(19) United States
(12) Patent Application Publication
(10) Pub. No.: US 2005/0041865 A1
(43) Pub. Date: Feb. 24, 2005

(54) Orientation determination for handwritten characters for recognition thereof

(76) Inventors: Li Xin Zhen, Shanghai (CN); Jian Cheng Huang, Shanghai (CN); Feng Jun Guo, Shanghai (CN)

Correspondence Address: MOTOROLA INC, 600 NORTH US HIGHWAY 45, ROOM AS437, LIBERTYVILLE, IL, 60048-5343, US

(21) Appl. No.: 10/955,581

(22) Filed: Sep. 30, 2004

(30) Foreign Application Priority Data
Mar. 24, 2003 (WO) PCT/EP03/03049

(51) Int. Cl. G06K 9/00

(52) U.S. Cl. 382/187

(57) ABSTRACT

According to one aspect of the invention there is provided a method (20) and electronic device (1) for determining orientation and recognition of handwritten characters scribed on touchscreen (5). The method (20) includes receiving (22) the hand written character and then normalizing (23) the character to provide a scaled character that fits within a defined boundary. The scaled character comprises at least one line and a step of identifying (24) the lines of the scaled character as a vector is effected and thereafter a step of rotating (26) rotates the scaled character from an initial orientation to a final orientation through a plurality of discrete orientations.

A step of calculating (27) then calculates, for each of the discrete orientations, magnitudes of co-ordinate components of each vector and then a summing step (28) then sums, for each of said discrete orientations, the co-ordinate components to provide a summed co-ordinate component for the scaled character at a corresponding discrete orientation. An assessing step (31) then assesses each of the summed co-ordinate components to determine a suitable orientation of the scaled character.

### FIELD OF THE INVENTION

This invention relates to determining orientation of handwritten characters provided to an electronic device. The invention is particularly useful for, but not necessarily limited to, recognizing characters that are input at a touch screen of the electronic device.

### BACKGROUND ART

Cellular telephones, Personal Digital Assistants (PDAs) and other similar portable electronic devices, and electronic devices in general, sometimes have an input tablet that is typically a touch screen providing a two-way user interface for data entry, invoking applications and menu traversing. Touch screens have evolved to allow a user to scribe and therefore input handwritten characters such as words, letters, alphanumeric strings, Asian characters (such as Chinese, Korean and Japanese Characters) and other indicia into an electronic device. The electronic device then processes and compares the handwritten characters, with characters stored in a recognition dictionary (memory), and identifies a best match that may then invoke a command or identify the scribed characters as input data to the electronic device. However, orientation of the scribed characters can affect processing and recognition that can lead to erroneous input data and commands.

In U.S. patent issued under U.S. Pat. No. 5,835,632 there is described a system that rotates a scribed input character through 360 degrees in 1 degree increments and attempts to recognize the character after each increment. This system can be computationally expensive due to the number of increments and corresponding recognition process. In U.S. patent issued under U.S. Pat. No. 6,226,404 there is described a character recognition system that learns a standard slant angle of characters scribed by a user. However, this system presumes the user will consistently scribe in a single orientation on the touch screen.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for determining orientation and recognition of at least one handwritten character scribed on an input interface associated with an electronic device, the method including the steps of:
receiving said hand written character scribed on said input interface;
normalizing said hand written character to provide a scaled character that fits within a defined boundary, said scaled character comprising at least one line;
identifying at least one said line of said scaled character as a vector;
rotating said scaled character from an initial orientation to a final orientation through a plurality of discrete orientations;
calculating, for each of said discrete orientations, magnitudes of co-ordinate components of each said vector;
summing, for each of said discrete orientations, said co-ordinate components to provide at least one summed co-ordinate component for said scaled character at a corresponding discrete orientation; and
assessing each said summed co-ordinate component to determine a suitable orientation of said scaled character, said suitable orientation being one of said discrete orientations.

Suitably, the step of assessing may be characterized by identifying said summed co-ordinate component with a largest value to thereby determine the suitable orientation of said scaled character.

Preferably, a direction of each vector may be suitably based upon a direction in which said line, associated therewith, was scribed.

Preferably, the method may include the further steps of:
comparing said scaled character when in said suitable orientation with template characters stored in a memory of said device; and
selecting from said template characters a recognized character that has the greatest similarity to said scaled character when in said suitable orientation.

Preferably, said step of comparing may be further characterized by said template characters comprising lines that are considered template character vectors, and said template characters are in an orientation based on summed co-ordinate components of said template character vectors.

The method may preferably include the further step of proving a signal that is dependent upon which character from said template of characters was selected as said recognized character.

Suitably, the method may include a transforming step for transforming curved portions of said input character into straight lines.

Suitably, the method may include the further step of providing output data indicative of said recognized character.

Preferably, the method may be further characterized by the input interface being a touch screen.

According to another aspect of the invention there is provided an electronic device comprising:
a processor; and
an input interface coupled to said processor,
wherein, in use, when at least one at least one handwritten character is scribed on the input interface the processor effects the steps of:
normalizing said hand written character to provide a scaled character that fits within a defined boundary, said scaled character comprising at least one line;
identifying at least one said line of said scaled character as a vector;
rotating said scaled character from an initial orientation to a final orientation through a plurality of discrete orientations;
calculating, for each of said discrete orientations, magnitudes of co-ordinate components of each said vector;
summing, for each of said discrete orientations, said co-ordinate components to provide at least one summed co-ordinate component for said scaled character at a corresponding discrete orientation; and
assessing each said summed co-ordinate component to determine a suitable orientation of said scaled character, said suitable orientation being one of said discrete orientations.

The electronic device may suitably effect any of the abovementioned steps.

Suitably, the input interface can be a touch screen.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a block diagram illustrating an embodiment of an electronic device in accordance with the invention;

FIG. 2 is a flow diagram illustrating a method for determining orientation of a handwritten character scribed on a touch screen of the electronic device of FIG. 1;

FIG. 3 is a flow diagram illustrating additional steps of the method of FIG. 2;

FIGS. 4a to 4c illustrate typical stroke directions of characters “M” and “W”;

FIGS. 5a to 5c illustrate typical stroke directions of Chinese characters “ [symbol] ” and “ [symbol] ”;

FIGS. 6a and 6b illustrate how the method of FIG. 2 is applied to identify orientation of a Chinese character representing the number 10;

FIGS. 7a and 7b illustrate how a step of Normalizing is effected in the method of FIG. 2; and

FIGS. 8a and 8b illustrate a transforming step that can be part of the method of FIG. 2.

### DETAILED DESCRIPTION OF THE PREFERRED EMBODIMENT OF THE INVENTION

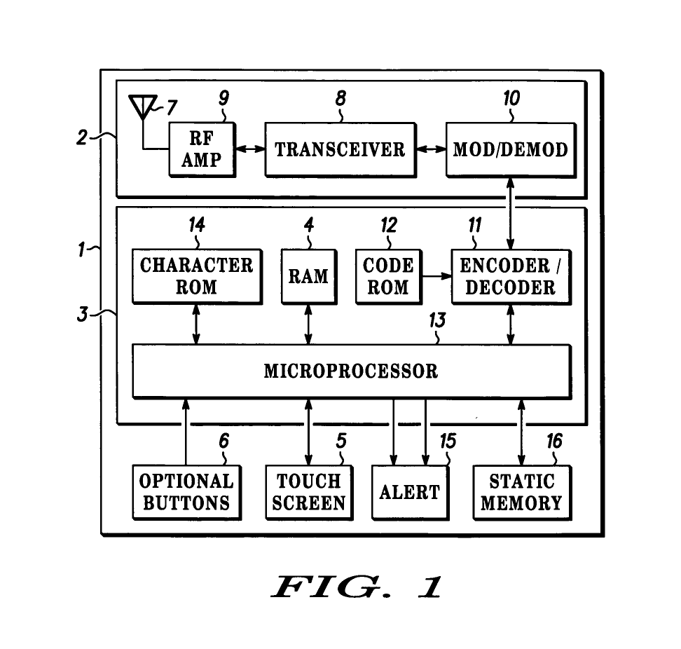

In the drawings, like numerals on different Figs are used to indicate like elements throughout. With reference to FIG. 1, there is illustrated an electronic device 1 comprising a radio frequency communications unit 2 coupled to be in communication with a processor 3. An input interface in the form of a touch screen 5 and optional buttons 6 are also coupled to be in communication with the processor 3.

The processor 3 includes an encoder/decoder 11 with an associated Read Only Memory 12 storing data for encoding and decoding voice or other signals that may be transmitted or received by electronic device 1. The processor 3 also includes a micro-processor 13 coupled to both an encoder/decoder 11 and an associated character Read Only Memory 14. Micro-processor 13 is also coupled to a Random Access Memory 4, the optional buttons 6, the touch screen 5 and a static programmable memory 16.

Auxiliary outputs of micro-processor 13 are coupled to an alert module 15 that typically contains a speaker, vibrator motor and associated drivers. The character Read only memory 14 stores code for decoding or encoding text messages that may be received by the communication unit 2, input at the touch screen 5 or input at the optional buttons 6. In this embodiment the character Read Only Memory 14 also stores operating code (OC) for micro-processor 13. The operating code (OC) is used to run applications on the electronic device 1.

The radio frequency communications unit 2 is a combined receiver and transmitter having a common antenna 7. The communications unit 2 has a transceiver 8 coupled to antenna 7 via a radio frequency amplifier 9. The transceiver 8 is also coupled to a combined modulator/demodulator 10 that couples the communications unit 2 to the processor 3.

The electronic device 1 can be any electronic device including a cellular telephone, a conventional type telephone, a laptop computer or a PDA. If the electronic device 1 is a cellular telephone, a user can select an application by traversing menus, or selecting icons, displayed on the touch screen 5.

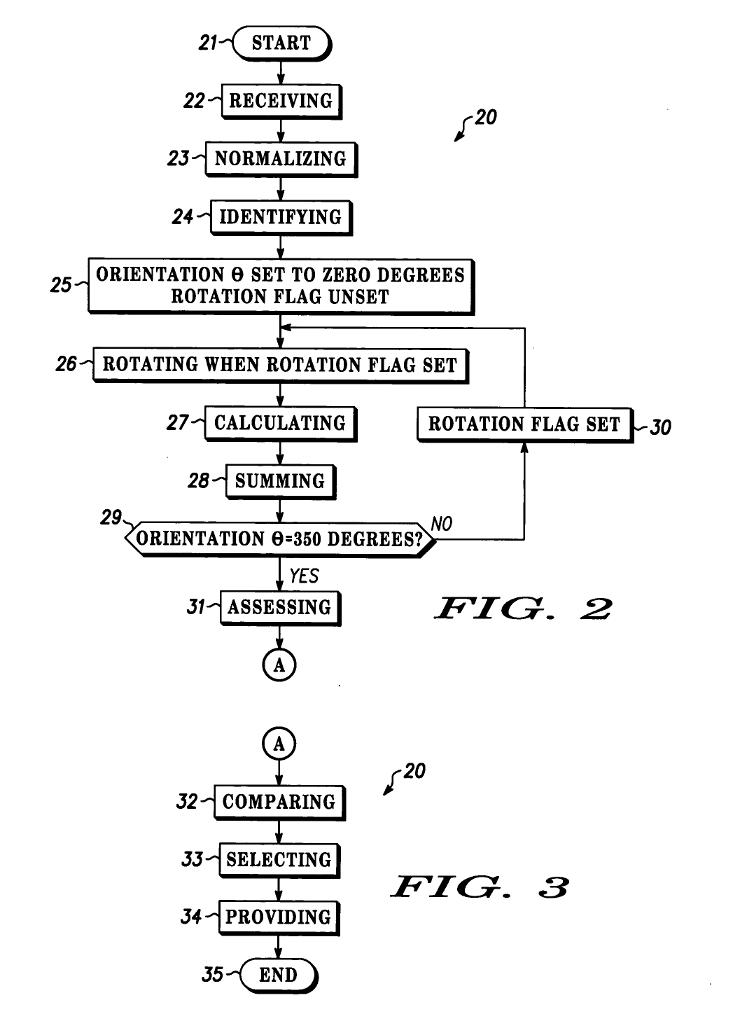

The touch screen 5 has an incorporated driver that is controllable by micro-processor 13. The touch screen 5 is two-way user input interface for typically allowing data entry, invoking device applications and commands, menu traversing, displaying text, displaying graphics and displaying menus. Data entry, and other user input requirements, to the touch screen 5 is typically by use of a stylus and may involve scribing characters onto the touch screen 5 as will be apparent to a person skilled in the art. However, recognition and subsequent processing of scribed characters may be impeded by their orientation and therefore referring to FIG. 2 there is illustrated a method 20 for determining orientation and recognition of a handwritten character scribed on the touch screen 5 associated with the device 1. The method 20 has steps that includes a start step 21, a step of receiving 22 the hand written character scribed on the touch screen 5 and then a step of normalizing 23 the hand written character to provide a scaled character that fits within a defined boundary.

The start step 21 is invoked typically when a stylus makes contact with the touch screen 5 and at the step of receiving 22 the processor 3 initializes sampling registers (Rs) in the Microprocessor 13. As each stroke of a character is scribed on the touch screen 5, the Microprocessor 13 takes samples of the stroke and stores a sampled version thereof in the sampling registers Rs to build a sampled character. When the stylus that is scribing the character is lifted from the touch screen 5, a timer is invoked and unless the stylus makes contact again with the touch screen 5 within a pre-defined interval of 0.5 seconds, it is assumed the character is completed and the step of normalizing 23 is effected on the sampled character stored in the sampling registers Rs. However, if the stylus makes contact again with the touch screen 5 within 0.5 seconds then the next stroke is sampled and forms part of the sampled character stored in the sampling registers Rs.

In the step of normalizing 23, the sampled character normalizes the sampled hand written character to provide a scaled character that fits within a defined boundary (typically the boundary effectively encloses an array of 64 by 64 pixels), wherein the scaled character comprises at least one line. A step of identifying 24 then identifies each line of the scaled character as a vector Vi and at a step 25 an orientation value θ is set to zero degrees (which is an initial orientation) and a rotation flag is UNSET. At a step of rotating 26 the scaled character is rotated typically 10 degrees when the rotation flag is SET. However, since the rotation flag on the first pass is UNSET no rotating occurs.

When the rotation flag is SET, then each time the step of rotating is invoked the scaled character is rotated from the initial orientation through 10 degrees to a new discrete orientation. At a step of calculating 27, for each discrete orientation, relative magnitudes of co-ordinate components of each vector Vi are calculated and at a step of summing 28, for each of the discrete orientations, the co-ordinate components are summed to provide a summed co-ordinate component for the scaled character at a corresponding discrete orientation. A test step 29 is then effected to determine if the orientation value θ equals 350 degrees (a final orientation) therefore determining that the scaled character has been rotated from the initial orientation to the final orientation through 10 degree discrete orientations. On the first pass, for instance, the rotation flag is unset and the orientation value θ equals 0 degrees. Accordingly, the rotation flag is SET at a step 30 and steps 26 to 28 are repeated until step 29 determines that the orientation value θ equals 350 degrees, thereafter an assessing step 31 assesses each summed co-ordinate component to determine a suitable orientation of the scaled character, suitable orientation being one of the discrete orientations.

As illustrated in FIG. 3, the method 20 further includes a step of comparing 32 the scaled character when in the suitable orientation with template characters stored in the memory 16 of the device 1. The template characters comprise lines that are considered template character vectors, and the template characters stored in memory 16 are in an orientation based on summed co-ordinate components of the template character vectors. This is achieved by individual normalized characters of, for instance, an alphanumeric character set or a Chinese character set being rotated in discrete 10 degree orientations to find their summed co-ordinate component with a largest value. The largest value thereby determines the suitable orientation of each template character.

A step of selecting 33 then follows for selecting from the template characters a recognized character that has the greatest similarity to the scaled character when in the suitable orientation. A step of providing 34 is then invoked for providing a signal that is dependent upon which character from the template of characters was selected as the recognized character. Output data is then provided that is indicative of the recognized character, the data may be information on the touch screen 5 such as the recognized character in an orientation that is expected by the user.

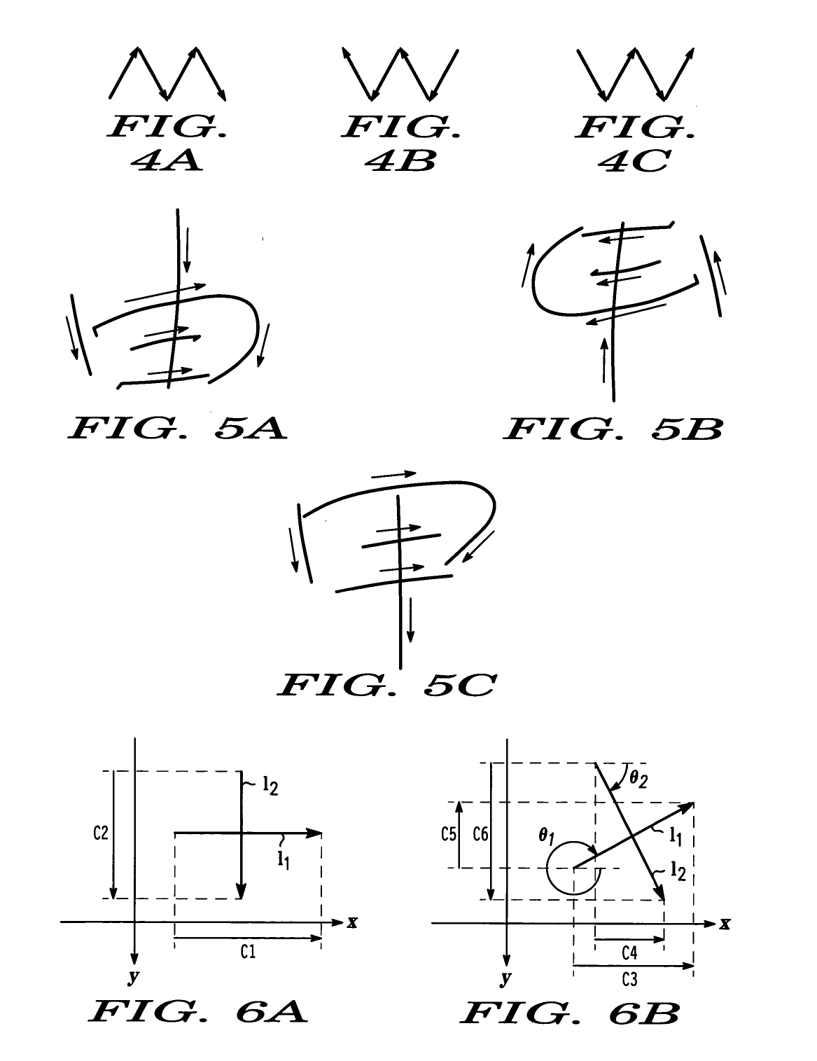

It should be noted that certain characters are similar to inverse or 90 degree rotations of other characters. For instance, some such characters include “M”-“W”, “N”-“Z”, “6”-“9”, and “ [symbol] ”-“ [symbol] ”. In the method 20, the characters basically comprise lines that are identified as vectors at step 24 with an associated direction. The vectors have associated co-ordinate components that are calculated at step 27 and summed at step 28 and assessed to determine a suitable orientation at step 31. In this regard, a direction of each vector may be suitably based upon a direction in which the line, associated therewith, was scribed. Accordingly, direction and magnitudes (size) of the vectors when composed into summed co-ordinate components advantageously identify a suitable orientation of a handwritten character that is typically created by strokes/scribes that conform to standard directions. This is illustrated in FIGS. 4a to 4c in which the arrows of FIG. 4a illustrate the direction of each stroke used to form lines of the character “M”. If the character “M” is rotated 180 degrees, as shown in FIG. 4b, so it resembles a character “W”, then the stroke direction is contrary to the direction of strokes forming a “W” as shown in FIG. 4c. Hence, the characters “M” and “W” when rotated can be distinguished by the method 20. A similar comparison for Chinese characters “ [symbol] ” and “ [symbol] ” is illustrated in FIGS. 5a to 5c.

It should also be noted that by stroke direction alone, orientation of some characters such as “N” and “Z” cannot be distinguished, however, the summed co-ordinate component values for these letters can be used to determine suitable orientation of these similar characters.

To further illustrate the invention, reference is made to FIGS. 6a and 6b which shows the Chinese character representing the number 10. For FIG. 6a, a co-ordinate component Cx in a direction parallel to an X axis is calculated, by the step of calculating 27, and is simply l₁. Similarly, a co-ordinate component Cy in a direction parallel to an Y axis is calculated, by the step of calculating 27, and is simply l₂. For FIG. 6b, the character has been rotated by the method 20 and the co-ordinate component Cx in a direction parallel to the X axis is calculated, by the step of calculating 27, as shown in equation (1). Further, the co-ordinate component Cy in a direction parallel to the Y axis is calculated, by the step of calculating 27, as shown in equation (2).
Cx=C3+C4=l₁. cos(θ₁)+l₂. cos(θ₂) (1)
Cy=C5+C6=l₁. sin(θ₁)+l₂. sin(θ₂) (2)

The character is rotated in 10 degree increments (discrete orientations) and values for Cx and Cy are calculated and summed to provide a summed co-ordinate component Cs for each of the discrete orientations. Accordingly, Cs=Cx+Cy and as will be apparent to a person skilled in the art, the values (magnitudes) for Cx and Cy are calculated by basic trigonometry and in some instances values for Cx or Cy or both may be negative (having a direction opposite to the direction of axis X and Y respectively). For example, in FIG. 6b, C5 is negative thereby substantially reducing the magnitude of Cy.

After the character has been rotated from the initial orientation to the final orientation the step of assessing 31 assesses each summed co-ordinate component Cs, for each of the discrete orientations, to determine a suitable orientation of the character. The suitable orientation is typically determined by identifying the summed co-ordinate component Cs that has the largest value.

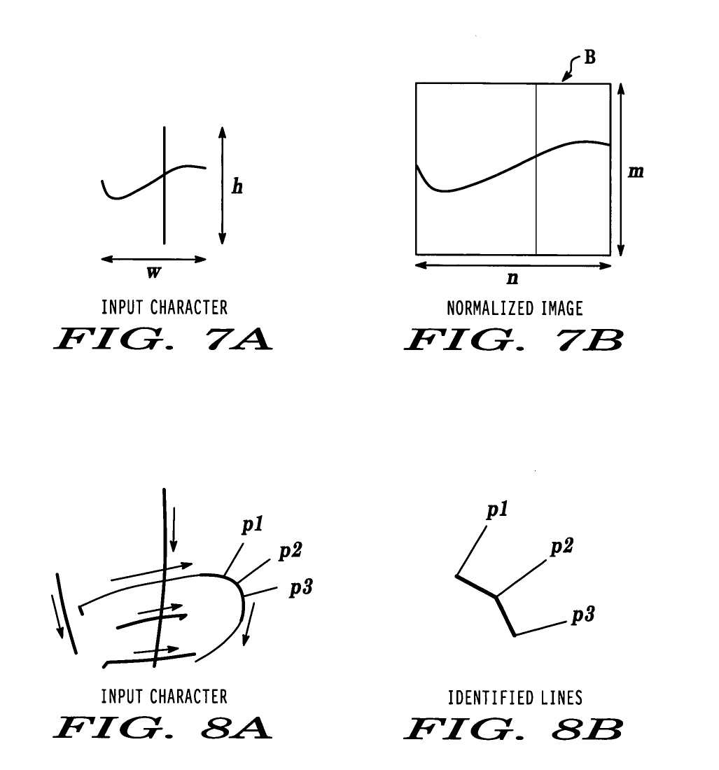

To further illustrate the step of normalizing 23, reference is now made to FIG. 7a that illustrates a handwritten character scribed on the touch screen 5. The step of Normalizing is based on interpolation and w and h identify the respective width and height of the input character in FIG. 7a. Further, n and m are the respective width and height of a predefined boundary B (or frame) of FIG. 7b. As will be apparent to a person skilled in the art, every input character is normalized to fit within the boundary B. Thus at the step of normalizing 23, varaibles In_[i] and In_y[i] are set to be x-y coordinates of a point of the input character of FIG. 7a. Also, N_x[j] and N_y[j] are set as x-y coordinates of the corresponding point in the normalized image of FIG. 7b. Thus, equations (3) and (4) below define the relationship for normalizing.
N_{—}x[j =In_{—}x[i].n/w (3)
N_{—}y[j]=In_{—}y[i].m/h (4)

Many scribed characters comprise curved lines that should be converted into straight lines for processing by the method 20. Therefore the method 20 can include a step of transforming curved lines of a character into straight lines for use in the step of identifying 24. In FIG. 8a, a scribed character having a curved portion input on touch screen 5 is illustrated. A part of the curved portion is between points p1 and p3. This curved portion is transformed into two straight lines p1 to p2 and p2 to p3 as illustrated in FIG. 8b. Accordingly, curved portions are decomposed into smaller portions and are then approximated into straight lines. This transforming step can be done either before or after the step of normalizing 23.

Advantageously, the present invention provides for a useful method and device for orientation determination and recognition of handwritten characters scribed on an input interface.

The detailed description provides a preferred exemplary embodiment only, and is not intended to limit the scope, applicability, or configuration of the invention. Rather, the detailed description of the preferred exemplary embodiment provides those skilled in the art with an enabling description for implementing a preferred exemplary embodiment of the invention. It should be understood that various changes may be made in the function and arrangement of elements without departing from the spirit and scope of the invention as set forth in the appended claims.

1. A method for determining orientation and recognition of at least one handwritten character scribed on an input interface associated with an electronic device, the method including the steps of:
receiving said hand written character scribed on said input interface;
normalizing said hand written character to provide a scaled character that fits within a defined boundary, said scaled character comprising at least one line;
identifying at least one said line of said scaled character as a vector;
rotating said scaled character from an initial orientation to a final orientation through a plurality of discrete orientations;
calculating, for each of said discrete orientations, magnitudes of co-ordinate components of each said vector;
summing, for each of said discrete orientations, said co-ordinate components to provide at least one summed co-ordinate component for said scaled character at a corresponding discrete orientation; and
assessing each said summed co-ordinate component to determine a suitable orientation of said scaled character, said suitable orientation being one of said discrete orientations.

2. A method as claimed in claim 1, wherein the step of assessing is characterized by identifying said summed co-ordinate component with a largest value to thereby determine the suitable orientation of said scaled character.

3. A method as claimed in claim 1, wherein a direction of each vector is based upon a direction in which said line, associated therewith, was scribed.

4. A method as claimed in claim 1, including the further steps of:
comparing said scaled character when in said suitable orientation with template characters stored in a memory of said device; and
selecting from said template characters a recognized character that has the greatest similarity to said scaled character when in said suitable orientation.

5. A method as claimed in claim 4, wherein said step of comparing is further characterized by said template characters comprising lines that are considered template character vectors, and said template characters are in an orientation based on summed co-ordinate components of said template character vectors.

6. A method as claimed in claim 5, the method including the further step of proving a signal that is dependent upon which character from said template of characters was selected as said recognized character.

7. A method as claimed in claim 1, further including a transforming step for transforming curved portions of said input character into straight lines.

8. A method as claimed in claim 5, the method including the further step of providing output data indicative of said recognized character.

9. A method as claimed in claim 1, wherein the input interface is a touch screen.

10. An electronic device comprising:
a processor; and
an input interface coupled to said processor,
wherein, in use, when at least one at least one handwritten character is scribed on the input interface the processor effects the steps of:
normalizing said hand written character to provide a scaled character that fits within a defined boundary, said scaled character comprising at least one line;
identifying at least one said line of said scaled character as a vector;
rotating said scaled character from an initial orientation to a final orientation through a plurality of discrete orientations;
calculating, for each of said discrete orientations, magnitudes of co-ordinate components of each said vector;
summing, for each of said discrete orientations, said co-ordinate components to provide at least one summed co-ordinate component for said scaled character at a corresponding discrete orientation; and
assessing each said summed co-ordinate component to determine a suitable orientation of said scaled character, said suitable orientation being one of said discrete orientations.
